(19) United States
(12) Patent Application Publication
(10) Pub. No.: US 2022/0129191 A1
(43) Pub. Date: Apr. 28, 2022

(54) METHOD, DEVICE, AND COMPUTER PROGRAM PRODUCT FOR STORAGE MANAGEMENT

(71) Applicant: EMC IP Holding Company LLc, Hopkinton, MA (US)

(72) Inventors: Chun Ma, Beijing (CN); Geng Han, Beijing (CN); Xinlei Xu, Beijing (CN); Changyu Feng, Beijing (CN); Jian Gao, Beijing (CN)

(21) Appl. No.: 17/190,807

(22) Filed: Mar. 3, 2021

(30) Foreign Application Priority Data
Oct. 22, 2020 (CN) 202011139415.9

(51) Int. Cl. G06F 3/06

(52) U.S. Cl. CPC G06F 3/0656; G06F 3/0631; G06F 3/0683; G06F 3/0619; G06F 3/0653

(57) ABSTRACT

Techniques provide storage management. Such techniques involve storing cache data of a buffer memory corresponding to a storage disk group into a standby disk based on a determination that the number of disks in a first disk set in the storage disk group is less than a threshold number of disks. The techniques further involve adjusting at least one disk in a second disk set to the first disk set so that the number of disks in the adjusted first disk set and the number of disks in the adjusted second disk set are both greater than or equal to the threshold number of disks. The techniques further involve loading a first part of data in the standby disk into the adjusted first disk set. In addition, the techniques further involve loading a second part of data in the standby disk into the adjusted second disk set.

### CROSS-REFERENCE TO RELATED APPLICATION

This application claims priority to Chinese Patent Application No. CN2020011139415.9, on file at the China National Intellectual Property Administration (CNIPA), having a filing date of Oct. 22, 2020, and having “METHOD, DEVICE, AND COMPUTER PROGRAM PRODUCT FOR STORAGE MANAGEMENT” as a title, the contents and teachings of which are herein incorporated by reference in their entirety.

### TECHNICAL FIELD

Embodiments of the present disclosure relate to the field of data storage, and more particularly, to a method, a device, and a computer program product for storage management.

### BACKGROUND

A nonvolatile random access memory (NVRAM) is a random access memory that can save data with no need to use a power supply. Compared with an ordinary solid state disk (SSD), the nonvolatile random access memory has higher performance and lower latency. In specific applications, a storage system usually groups the nonvolatile random access memory into a disk pair that includes two disks or a disk set that includes more disks. Furthermore, a redundant array of independent disks (RAID, also known as a “disk array”) may use the disk pair or the disk set to build a logger tier. That is, a plurality of disk pairs or sets can form one RAID, which provides higher storage capacity than a single hard disk, and can also provide data backup. However, when any disk pair or disk set in the RAID goes offline due to reasons such as poor contact or failure, the RAID is unavailable, and requires a relatively long wait for manual repair.

### SUMMARY OF THE INVENTION

Embodiments of the present disclosure provide a method, a device, and a computer program product for storage management.

According to a first aspect of the present disclosure, a storage management method is provided. The method includes storing cache data of a buffer memory corresponding to a storage disk group into a standby disk based on a determination that the number of disks in a first disk set in the storage disk group is less than a threshold number of disks. The cache data includes a first part of data corresponding to the first disk set and a second part of data corresponding to the second disk set in the storage disk group, and the number of disks in the second disk set is greater than the threshold number of disks. The method further includes adjusting at least one disk in the second disk set to the first disk set so that the number of disks in the adjusted first disk set and the number of disks in the adjusted second disk set are both greater than or equal to the threshold number of disks. The method further includes loading a first part of data in the standby disk into the adjusted first disk set. In addition, the method further includes loading a second part of data in the standby disk into the adjusted second disk set.

According to a second aspect of the present disclosure, an electronic device is provided. The electronic device includes: a processor; and a memory having computer program instructions stored thereon. The processor executes the computer program instructions in the memory to control the electronic device to perform actions. The actions include: storing cache data in a buffer memory corresponding to the storage disk group into a standby disk based on a determination that the number of disks in a first disk set in a storage disk group is less than a threshold number of disks, wherein the cache data includes a first part of data corresponding to the first disk set and a second part of data corresponding to a second disk set in the storage disk group, and the number of disks in the second disk set is greater than the threshold number of disks; adjusting at least one disk in the second disk set to the first disk set so that the number of disks in the adjusted first disk set and the number of disks in the adjusted second disk set are both greater than or equal to the threshold number of disks; loading the first part of data in the standby disk into the adjusted first disk set; and loading the second part of data in the standby disk into the adjusted second disk set.

According to a third aspect of the present disclosure, a computer program product is provided. The computer program product is tangibly stored on a nonvolatile computer-readable medium and includes machine-executable instructions; and the machine-executable instructions, when executed, cause a machine to perform the steps of the method in the first aspect of the present disclosure.

### BRIEF DESCRIPTION OF THE DRAWINGS

The above and other objectives, features, and advantages of the present disclosure will become more apparent by describing the example embodiments of the present disclosure in more detail in combination with the accompanying drawings. In the example embodiments of the present disclosure, the same reference numerals generally represent the same parts.

FIG. 1 shows a schematic diagram of an example storage system in which an embodiment of the present disclosure may be implemented;

FIG. 2 shows a flowchart of a process for storage management according to an embodiment of the present disclosure;

FIG. 3A shows a schematic diagram of an example storage system for storage management according to an embodiment of the present disclosure;

FIG. 3B shows a schematic diagram of an example storage system for storage management according to an embodiment of the present disclosure;

FIG. 3C shows a schematic diagram of an example storage system for storage management according to an embodiment of the present disclosure;

FIG. 3D shows a schematic diagram of an example storage system after data in the disk set is restored according to an embodiment of the present disclosure;

FIG. 3E shows a schematic diagram of an example storage system with increased disks according to an embodiment of the present disclosure; and

FIG. 4 is a schematic block diagram of an example device applicable to implementing an embodiment of the present disclosure.

In the accompanying drawings, the same or corresponding numerals represent the same or corresponding parts.

### DETAILED DESCRIPTION

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

Embodiments of the present disclosure will be described in more detail below with reference to the accompanying drawings. Although some embodiments of the present disclosure are illustrated in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are for illustrative purposes only, and are not intended to limit the scope of protection of the present disclosure.

In the description of the embodiments of the present disclosure, the term “include” and similar terms thereof should be understood as open-ended inclusion, i.e., “including but not limited to.” The term “based on” should be understood as “based at least in part on.” The term “one embodiment” or “the embodiment” should be understood as “at least one embodiment.” The terms “first,” “second,” etc. may refer to different or identical objects. Other explicit and implicit definitions may also be included below.

The principles of the present disclosure will be described below with reference to several example embodiments shown in the accompanying drawings. Although preferred embodiments of the present disclosure are shown in the accompanying drawings, it should be understood that these embodiments are described only to enable those skilled in the art to better understand and then implement the present disclosure, and are not intended to impose any limitation on the scope of the present disclosure.

When a plurality of disks are stored in association, if some disks are unavailable, the entire disk array is unavailable. For example, a RAID has similar problems. A RAID is a storage disk group composed of a plurality of independent disks combined in different ways. From the user's perspective, the redundant array of independent disks is like a disk, which can provide a higher storage capacity than a single hard disk, and can also provide data backup. Take the case of disk pairs as an example. When the RAID uses a plurality of disk pairs to build a logger tier, once two disks in a disk pair in the logger tier are damaged or offline, the system will save the data in the buffer memory into a standby disk such as a solid state disk and be shut down until the staff repairs or replaces the damaged disk. After that, the system will restore the data in the standby disk into the buffer memory and the repaired disk pair. It can be seen that when a disk pair is unavailable, the system can only be repaired and restarted manually, and this process lasts for a relatively long time, which easily brings poor user experience.

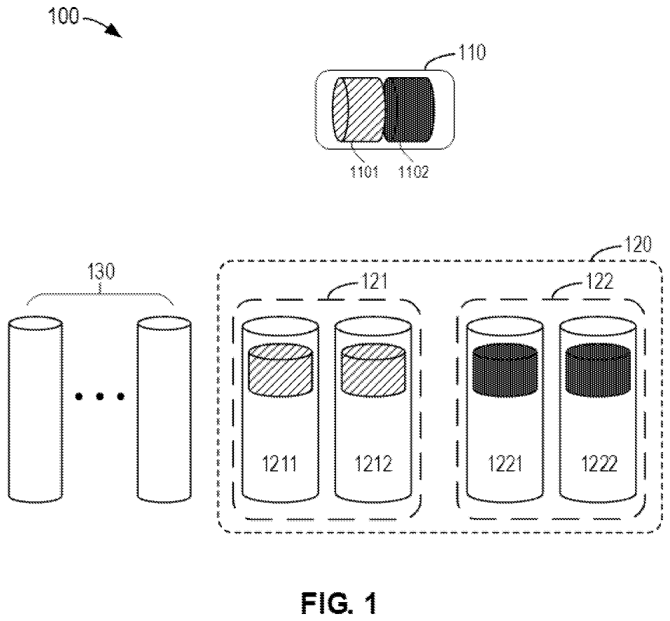

In order to optimize a storage mechanism, the present disclosure proposes a new storage management solution, which makes full use of redundant disks of other disk pairs or disk sets in the same logger tier to replace failed disks, so as to maintain the normal operation of the storage system. For a better understanding of a storage management process according to the embodiments of the present disclosure, a basic structure of RAID-based storage will be first introduced below with reference to FIG. 1.

FIG. 1 shows a schematic diagram of example storage system 100 in which an embodiment of the present disclosure may be implemented. In storage system 100, buffer memory 110, storage disk group (i.e., the “logger tier” above) 120, and standby disk 130 may be in communication connection and may all be used to store data. Cache data 1101 and 1102 to be written are stored in buffer memory 110. Storage disk group 120 may at least include first disk set 121 and second disk set 122. First disk set 121 includes disk 1211 and disk 1212 for storing data written from buffer memory 110, and second disk set 122 includes disk 1221 and disk 1222 for storing data written from buffer memory 110.

It should be understood that cache data 1101 stored in buffer memory 110 is generally the same as the data stored in disk 1211 and disk 1212, and cache data 1102 stored in buffer memory 110 is generally the same as the data stored in disk 1221 and disk 1222. The only exception is that cache data 1101 and 1102 in buffer memory 110 have just been updated, and have not yet been written into disks 1211 and 1212 and disks 1221 and 1222.

It should be understood that the storage disks described above may include various types of devices having a storage function, including but not limited to a hard disk drive (HDD), a solid state disk (SSD), a removable disk, a compact disk (CD), a laser disk, an optical disk, a digital versatile disk (DVD), a floppy disk, a blu-ray disk, a serial-attached small computer system Interface (SCSI) storage disk (SAS), a serial advanced technology attachment (SATA) storage disk, any other magnetic storage devices and any other optical storage devices, or any combination thereof.

Preferably, disks 1211 and 1212 and disks 1221 and 1222 each may be a nonvolatile random access memory (NVRAM), and standby disk 130 may be a solid state disk (SSD), which is used to store cache data 1101 and 1102 when storage disk group 120 and buffer memory 110 are restarted. Although the nonvolatile random access memory is “nonvolatile,” a sudden power failure can still cause data loss in the nonvolatile random access memory. Therefore, the nonvolatile random access memory requires a backup battery unit (BBU) to protect the validity of data after power failure. In some embodiments, each disk in first disk set 121 and each disk in second disk set 122 are configured with different backup battery units, thereby providing reliable power supply guarantee.

It should also be understood that, in order to avoid a more complicated illustration of the idea of the present disclosure, example storage system 100 in FIG. 1 only shows the case of a disk set including a pair of disks. In fact, in addition to the RAID 1-like storage structure of disk set 121, the number of disks in the disk set may also be any other number. For example, disk sets 121 and 122 may each include five disks so as to form RAID 5. In addition, although FIG. 1 shows that storage disk group 120 includes two disk sets, in fact, storage disk group 120 may include more disk sets. The above examples are only for illustrating the present disclosure, rather than limiting the present disclosure.

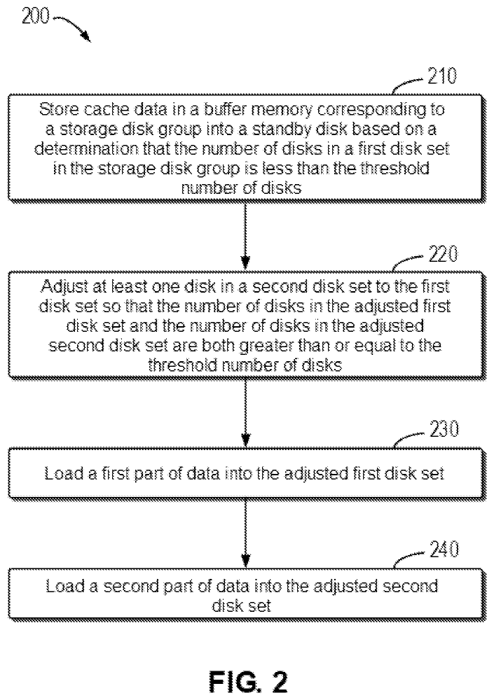

When it is determined that disk set 121 is unavailable, the system of the present disclosure may be automatically restored in a relatively short time by executing the process for storage management as shown in FIG. 2. A flowchart of the process for storage management will be described in detail below in conjunction with FIG. 2.

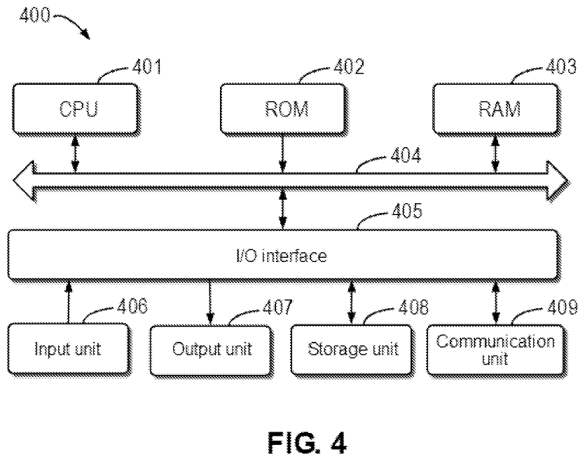

FIG. 2 shows a flowchart of process 200 for storage management according to an embodiment of the present disclosure. In some embodiments, process 200 may be implemented in the device shown in FIG. 4. For ease of understanding, the specific data mentioned in the following description are all examples and are not intended to limit the scope of protection of the present disclosure.

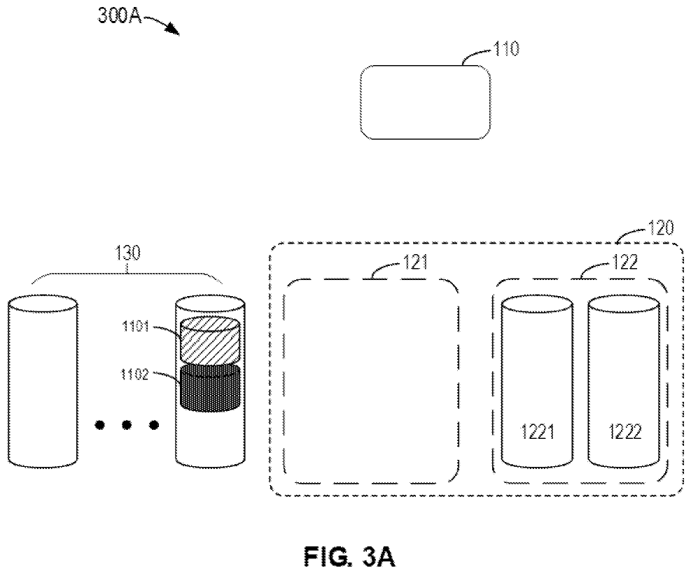

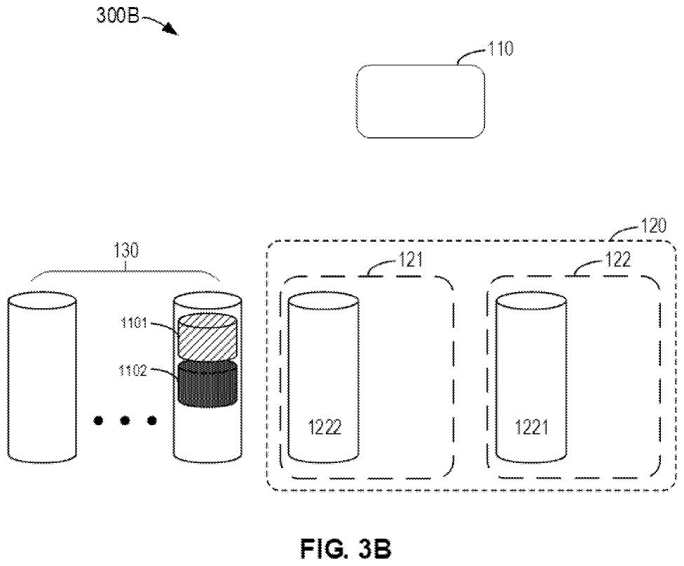

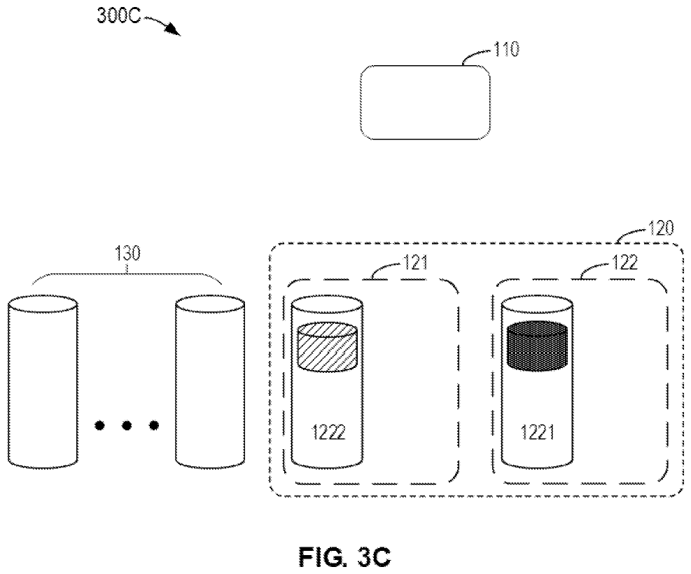

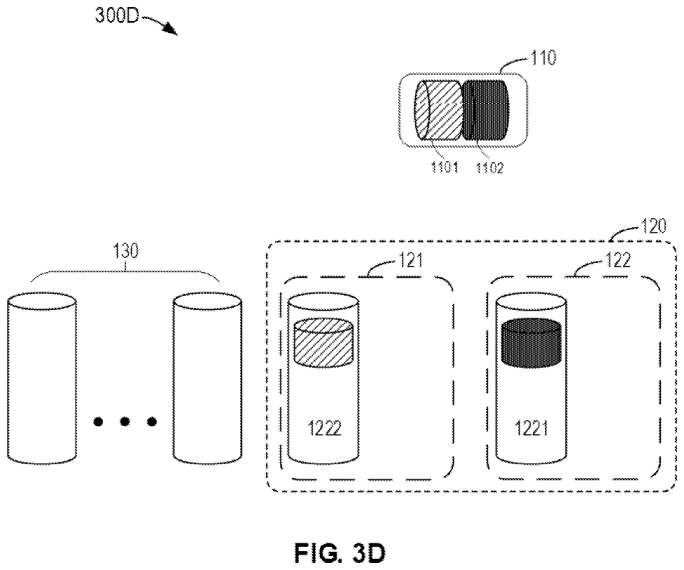

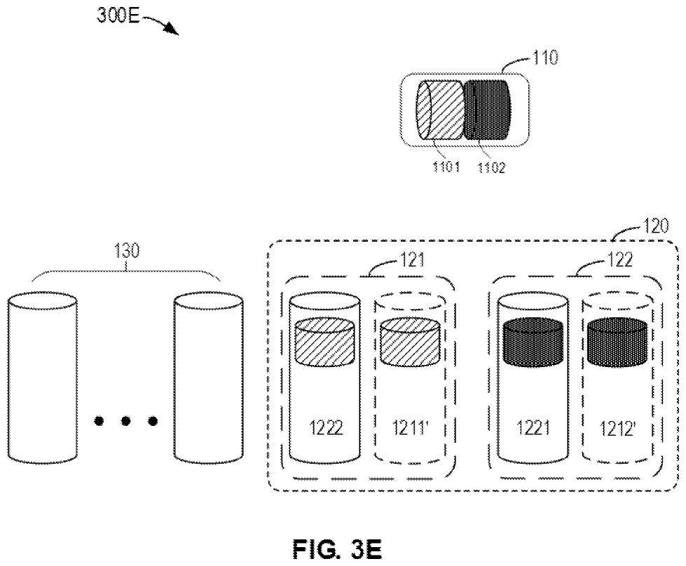

At 210, if it is determined that the number of disks in first disk set 121 in storage disk group 120 is less than the threshold number of disks, the storage system stores cache data 1101 and 1102 in buffer memory 110 corresponding to storage disk group 120 into standby disk 130. It should be understood that cache data 1101 and 1102 include the first part of data corresponding to first disk set 121 and the second part of data corresponding to second disk set 122 in storage disk group 120, and the number of disks in second disk set 122 is greater than the threshold number of disks. Details of the process are described in detail below with reference to FIG. 3A.

FIG. 3A shows a schematic diagram of example storage system 300A for storage management according to an embodiment of the present disclosure. As shown in FIG. 3A, since a sufficient number of storage disks cannot be detected in first disk set 121, it is determined that first disk set 121 is unavailable or offline. At this time, cache data 1101 and 1102 in buffer memory 110 can be backed up to standby disk 130. As an example, in the case where first disk set 121 is configured with a pair of disks 1211 and 1212 (for example, RAID 1), if only disk 1211 or disk 1212 is unavailable, first disk set 121 can still continue to work. If neither disk 1211 nor disk 1212 is available, that is, the number of disks in first disk set 121 detected by the storage system is less than one, it can be determined that first disk set 121 is unavailable. At this time, the backup operation of buffer memory 110 is started.

As another example, in the case where first disk set 121 is configured with five disks (for example, RAID 5), if only one disk is unavailable, first disk set 121 can still continue to work. However, if two disks are unavailable, and the number of disks in first disk set 121 detected by the storage system is less than four, then it can be determined that first disk set 121 is unavailable. At this time, the backup operation of buffer memory 110 is started.

In addition, in order to maintain the scene, the storage system can directly store cache data 1101 and 1102 in buffer memory 110 into standby disk 130. It should be understood that when disks 1211 and 1212 and disks 1221 and 1222 are nonvolatile random access memories, cache data 1101 and 1102 stored in buffer memory 110 may be exactly the same as the data stored in disks 1211 and 1212 and disks 1221 and 1222 due to the small storage capacity thereof. Therefore, when first disk set 121 is unavailable, the data in buffer memory 110 can be directly backed up without considering the data in second disk set 122 that is still available.

Back to FIG. 2. At 220, at least one disk 1222 in second disk set 122 can be adjusted to first disk set 121 so that the number of disks in the adjusted first disk set 121 and the number of disks in the adjusted second disk set 122 are both greater than or equal to the threshold number of disks. Details of the above-mentioned adjustment process are described in detail below with reference to FIG. 3B.

FIG. 3B shows a schematic diagram of example storage system 300B for storage management according to an embodiment of the present disclosure. As shown in FIG. 3B, disk 1222 originally belonging to second disk set 122 is adjusted to first disk set 121. As an example, in the case where first disk set 121 and second disk set 122 are both configured with a pair of disks (for example, RAID 1), one disk in second disk set 122 may be adjusted to first disk set 121. At this time, the number of disks in first disk set 121 and second disk set 122 are both one, which is equal to the threshold number of disks, one.

As another example, in the case where first disk set 121 and second disk set 122 are both configured with five disks (for example, RAID 5), if only three disks in first disk set 121 are available, one disk in second disk set 122 may be adjusted to first disk set 121. At this time, the number of disks in first disk set 121 and the number of disks second disk set 122 are both four, which is equal to the threshold number of disks, four.

In addition, due to some software or hardware reasons, the disk that is detected as unavailable may still be available after a restart operation. Therefore, in this case, storage disk group 120 and buffer memory 110 may be restarted, or the entire system may be restarted. After the restart operation, the number of disks in first disk set 121 may be further determined. If the number of disks in first disk set 121 is still less than the threshold number of disks at this time, one disk in second disk set 122 may be adjusted to first disk set 121.

Preferably, it is possible to determine whether a sum of the number of disks in first disk set 121 and the number of disks in second disk set 122 is greater than or equal to twice the threshold number of disks while determining whether the number of disks in first disk set 121 is less than the threshold number of disks. When these two determination conditions are met at the same time, at least one disk in second disk set 122 is adjusted to first disk set 121. On the other hand, if the number of disks in first disk set 121 is found to be still greater than or equal to the threshold number of disks after restart, it indicates that the unavailable disks can continue to be used after restart, so that the system can continue to be used normally. Through the above-mentioned operations including restart, it is possible to repair unavailable disks, so that the system can be restored quickly.

Back to FIG. 2. At 230, the first part of data in standby disk 130 is loaded into the adjusted first disk set 121. And at 240, the second part of data in standby disk 130 is loaded into the adjusted second disk set 122. Specifically, the first part of data and the second part of data in standby disk 130 are loaded into disk 1222 in the adjusted first disk set 121 and disk 1221 in the adjusted second disk set 122, respectively. Details of the data restoration process are described in detail below with reference to FIG. 3C.

FIG. 3C shows a schematic diagram of example storage system 300C for storage management according to an embodiment of the present disclosure. As shown in FIG. 3B, disk 1222 exists in the adjusted first disk set 121 and is used to store the first part of data originally stored in first disk set 121. Similarly, disk 1221 exists in the adjusted second disk set 122 and is used to store the second part of data originally stored in first disk set 122. At this time, the system completes the automatic backup and restoration of the data in first disk set 121 and second disk set 122.

FIG. 3D shows a schematic diagram of an example storage system after data in the disk sets is restored according to an embodiment of the present disclosure. As shown in FIG. 3D, the first part of data stored in disk 1222 in first disk set 121 and the second part of data stored in disk 1221 in second disk set 122 are reloaded into buffer memory 110 as reloaded cache data 1101 and 1102. In this way, the system realizes the automatic restoration of the data in buffer memory 110.

In some preferred embodiments, in order to improve the storage performance of storage disk group 120, it is necessary to repair and replace the inoperable disks. FIG. 3E shows a schematic diagram of example storage system 300E with increased disks according to an embodiment of the present disclosure. As shown in FIG. 3E, when the staff reinserts disks 1211′ and 1212′, the system detects that the number of disks in storage disk group 120 has increased, so that based on the reloaded cache data 1101 and 1102 in buffer memory 110, the adjusted first disk set 121 and the adjusted second disk set 122 are restored to first disk set 121 and second disk set 122 before adjustment. Specifically, the reloaded cache data 1101 and 1102 in buffer memory 110 may be copied to the newly added disk 1211′ in first disk set 121 and the newly added disk 1212′ in second disk set 122, respectively. In this way, example storage system 300E is restored to be basically the same as example storage system 100, and the length of time the system is unavailable during the entire process is only a few seconds or less, thereby significantly shortening the system restoration time and improving user experience.

Through the above-mentioned embodiment, even if an individual disk set is unavailable, the normal operation of storage disk group 120 can still be ensured by adjusting the disks in each disk set. That is, when an individual disk set is unavailable and causes the storage disk group to be unable to work normally, according to the above-mentioned embodiment of the present disclosure, the redundant disks in other disk sets may be adjusted to the inoperable disk set, so that the number of disks in the disk set may reach the threshold number of disks. As a result, it can be automatically realized that all disk sets in the storage disk group are available. The whole process does not require manual intervention, and it only takes a few seconds to shut down and restart the system (stopping I/O during this period), which improves the efficiency of system maintenance.

FIG. 4 is a schematic block diagram of example device 400 applicable to implementing an embodiment of the present disclosure. As shown in the drawing, device 400 includes central processing unit (CPU) 401 that may perform various appropriate actions and processing according to computer program instructions stored in read-only memory (ROM) 402 or computer program instructions loaded from storage unit 408 into random access memory (RAM) 403. In RAM 403, various programs and data required for the operation of device 400 may also be stored. CPU 401, ROM 402, and RAM 403 are connected to each other through bus 404. Input/output (I/O) interface 405 is also connected to bus 404.

A plurality of components in device 400 are connected to I/O interface 405, including: input unit 406, such as a keyboard and a mouse; output unit 407, such as various types of displays and speakers; storage unit 408, such as a magnetic disk and an optical disk; and communication unit 409, such as a network card, a modem, and a wireless communication transceiver. Communication unit 409 allows device 400 to exchange information/data with other devices over a computer network such as the Internet and/or various telecommunication networks.

The various processes and processing described above, such as process 200, may be performed by processing unit 401. For example, in some embodiments, process 200 may be implemented as a computer software program that is tangibly included in a machine-readable medium, for example, storage unit 408. In some embodiments, part or all of the computer program may be loaded and/or mounted to device 400 via ROM 402 and/or communication unit 409. When the computer program is loaded into RAM 403 and executed by CPU 401, one or more actions of process 200 described above may be implemented.

The present disclosure may be a method, an apparatus, a system, and/or a computer program product. The computer program product may include a computer-readable storage medium on which computer-readable program instructions for performing various aspects of the present disclosure are loaded.

The computer-readable storage medium may be a tangible device that can hold and store instructions used by an instruction-executing device. For example, the computer-readable storage medium may be, but is not limited to, an electrical storage device, a magnetic storage device, an optical storage device, an electromagnetic storage device, a semiconductor storage device, or any appropriate combination of the above. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical coding device such as a punch card or protrusions in a groove on which instructions are stored, and any appropriate combination of the above. Computer-readable storage media used herein are not to be interpreted as transient signals per se, such as radio waves or other freely propagating electromagnetic waves, electromagnetic waves propagating through waveguides or other transmission media (for example, light pulses through fiber optic cables), or electrical signal transmitted via electrical wires.

The computer-readable program instructions described herein can be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. The network adapter card or network interface in each computing/processing device receives computer-readable program instructions from the network and forwards the computer-readable program instructions for storage in a computer-readable storage medium in each computing/processing device.

Computer program instructions for performing the operations of the present disclosure may be assembly instructions, instruction set architecture (ISA) instructions, machine instructions, machine-related instructions, microcode, firmware instructions, state setting data, or source or object code written in any combination of one or more programming languages, wherein the programming languages include object-oriented programming languages, such as Smalltalk and C++, and conventional procedural programming languages, such as the “C” language or similar programming languages. Computer-readable program instructions may be executed entirely on a user's computer, partly on a user's computer, as a stand-alone software package, partly on a user's computer and partly on a remote computer, or entirely on a remote computer or a server. In the case involving a remote computer, the remote computer can be connected to a user's computer through any kind of network, including a local area network (LAN) or a wide area network (WAN), or it can be connected to an external computer (for example, connected through an Internet using an Internet service provider). In some embodiments, an electronic circuit, for example, a programmable logic circuit, a field programmable gate array (FPGA), or a programmable logic array (PLA), is personalized by utilizing the state information of the computer-readable program instructions, wherein the electronic circuit may execute computer-readable program instructions so as to implement various aspects of the present disclosure.

Various aspects of the present disclosure are described herein with reference to flowcharts and/or block diagrams of the method, the apparatus (system), and the computer program product according to embodiments of the present disclosure. It should be understood that each block in the flowcharts and/or block diagrams as well as a combination of blocks in the flowcharts and/or block diagrams may be implemented by using the computer-readable program instructions.

These computer-readable program instructions can be provided to a processing unit of a general-purpose computer, a special-purpose computer, or a further programmable data processing apparatus, thereby producing a machine, such that these instructions, when executed by the processing unit of the computer or the further programmable data processing apparatus, produce means (e.g., specialized circuitry) for implementing the functions/actions specified in one or more blocks in the flowcharts and/or block diagrams. These computer-readable program instructions may also be stored in a computer-readable storage medium, and these instructions cause a computer, a programmable data processing apparatus, and/or other devices to work in a specific manner; and thus the computer-readable medium having stored instructions includes an article of manufacture including instructions that implement various aspects of the functions/actions specified in one or more blocks in the flowcharts and/or block diagrams.

The computer-readable program instructions can also be loaded onto a computer, a further programmable data processing apparatus, or a further device, so that a series of operating steps can be performed on the computer, the further programmable data processing apparatus, or the further device to produce a computer-implemented process, such that the instructions executed on the computer, the further programmable data processing apparatus, or the further device can implement the functions/actions specified in one or more blocks in the flowcharts and/or block diagrams.

The flowcharts and block diagrams in the accompanying drawings illustrate the architectures, functions, and operations of possible implementations of the systems, methods, and computer program products according to various embodiments of the present disclosure. In this regard, each block in the flowcharts or block diagrams may represent a module, a program segment, or part of an instruction, the module, program segment, or part of an instruction including one or more executable instructions for implementing specified logical functions. In some alternative implementations, the functions marked in the blocks may also occur in an order different from that marked in the accompanying drawings. For example, two successive blocks may actually be executed in parallel substantially, or they may be executed in an opposite order sometimes, depending on the functions involved. It should be further noted that each block in the block diagrams and/or flowcharts as well as a combination of blocks in the block diagrams and/or flowcharts may be implemented by using a special hardware-based system for executing specified functions or actions or by a combination of special hardware and computer instructions.

Various embodiments of the present disclosure have been described above. The foregoing description is illustrative rather than exhaustive, and is not limited to the disclosed embodiments. Numerous modifications and alterations are apparent to those of ordinary skill in the art without departing from the scope and spirit of the illustrated various embodiments. The selection of terms as used herein is intended to best explain the principles and practical applications of the various embodiments or technical improvements to technologies on the market, or to enable other persons of ordinary skill in the art to understand the various embodiments disclosed herein.

As explained herein, the time for shutting down and restarting the system due to a disk failure may be shortened. Accordingly, the techniques disclosed herein enable improving the efficiency of system maintenance.

1. A storage management method, comprising:
storing cache data in a buffer memory corresponding to a storage disk group into a standby disk based on a determination that the number of disks in a first disk set in the storage disk group is less than a threshold number of disks, wherein the cache data comprises a first part of data corresponding to the first disk set and a second part of data corresponding to a second disk set in the storage disk group, and the number of disks in the second disk set is greater than the threshold number of disks;
adjusting at least one disk in the second disk set to the first disk set so that the number of disks in the adjusted first disk set and the number of disks in the adjusted second disk set are both greater than or equal to the threshold number of disks;
loading the first part of data in the standby disk into the adjusted first disk set; and
loading the second part of data in the standby disk into the adjusted second disk set.

2. The method according to claim 1, wherein adjusting the at least one disk in the second disk set to the first disk set comprises:
restarting the storage disk group and the buffer memory;
determining the number of disks in the first disk set; and
in response to that the number of disks in the first disk set is less than the threshold number of disks and a sum of the number of disks in the first disk set and the number of disks in the second disk set is greater than or equal to twice the threshold number of disks, adjusting at least one disk in the second disk set to the first disk set.

3. The method according to claim 2, further comprising:
reloading the first part of data in the first disk set and the second part of data in the second disk set into the buffer memory as the reloaded cache data.

4. The method according to claim 3, further comprising:
based on a determination that the number of disks in the storage disk group has increased, restoring the adjusted first disk set and the adjusted second disk set to the first disk set and the second disk set before adjustment, based on the reloaded cache data in the buffer memory.

5. The method according to claim 1, wherein each disk in the first disk set and each disk in the second disk set are nonvolatile random access memories and are configured with different backup battery units.

6. The method according to claim 2, wherein the standby disk is a solid state disk for storing the cache data when the storage disk group and the buffer memory are restarted.

7. An electronic device, comprising:
at least one processing unit; and
at least one memory, coupled to the at least one processing unit and having machine-executable instructions stored thereon, wherein when executed by the at least one processing unit, the instructions cause the device to perform actions, and the actions comprise:
storing cache data in a buffer memory corresponding to the storage disk group into a standby disk based on a determination that the number of disks in a first disk set in a storage disk group is less than a threshold number of disks, wherein the cache data comprises a first part of data corresponding to the first disk set and a second part of data corresponding to a second disk set in the storage disk group, and the number of disks in the second disk set is greater than the threshold number of disks;
adjusting at least one disk in the second disk set to the first disk set so that the number of disks in the adjusted first disk set and the number of disks in the adjusted second disk set are both greater than or equal to the threshold number of disks;
loading the first part of data in the standby disk into the adjusted first disk set; and
loading the second part of data in the standby disk into the adjusted second disk set.

8. The device according to claim 1, wherein adjusting the at least one disk in the second disk set to the first disk set comprises:
restarting the storage disk group and the buffer memory;
determining the number of disks in the first disk set; and
in response to that the number of disks in the first disk set is less than the threshold number of disks and a sum of the number of disks in the first disk set and the number of disks in the second disk set is greater than or equal to twice the threshold number of disks, adjusting at least one disk in the second disk set to the first disk set.

9. The device according to claim 8, wherein the actions further comprise:
reloading the first part of data in the first disk set and the second part of data in the second disk set into the buffer memory as the reloaded cache data.

10. The device according to claim 9, wherein the actions further comprise:
based on a determination that the number of disks in the storage disk group has increased, restoring the adjusted first disk set and the adjusted second disk set to the first disk set and the second disk set before adjustment, based on the reloaded cache data in the buffer memory.

11. The device according to claim 7, wherein each disk in the first disk set and each disk in the second disk set are nonvolatile random access memories and are configured with different backup battery units.

12. The device according to claim 8, wherein the standby disk is a solid state disk for storing the cache data when the storage disk group and the buffer memory are restarted.

13. A computer program product having a non-transitory computer readable medium which stores a set of instructions to perform storage management; the set of instructions, when carried out by computerized circuitry, causing the computerized circuitry to perform a method of:
storing cache data in a buffer memory corresponding to a storage disk group into a standby disk based on a determination that the number of disks in a first disk set in the storage disk group is less than a threshold number of disks, wherein the cache data comprises a first part of data corresponding to the first disk set and a second part of data corresponding to a second disk set in the storage disk group, and the number of disks in the second disk set is greater than the threshold number of disks;
adjusting at least one disk in the second disk set to the first disk set so that the number of disks in the adjusted first disk set and the number of disks in the adjusted second disk set are both greater than or equal to the threshold number of disks;
loading the first part of data in the standby disk into the adjusted first disk set; and
loading the second part of data in the standby disk into the adjusted second disk set.
